(19) United States
(12) Patent Application Publication
(10) Pub. No.: US 2013/0340836 A1
(43) Pub. Date: Dec. 26, 2013

(54) Overflow protection system for a fluid transfer system

(71) Applicant: Daniel Wambold, Franklin Lakes, NJ (US)

(72) Inventor: Daniel Wambold, Franklin Lakes, NJ (US)

(21) Appl. No.: 13/922,420

(22) Filed: Jun. 20, 2013

Related U.S. Application Data
(60) Provisional application No. 61/662,708, filed on Jun. 21, 2012.

(51) Int. Cl. G05D 7/06; F16K 37/00

(52) U.S. Cl. CPC G05D 7/0617; F16K 37/00
USPC 137/10; 137/486; 137/551

(57) ABSTRACT

In one embodiment, an overflow protection system for a fluid transfer system with an opening to the environment comprises at least one sensor and a fluid flow regulating device in communication with the at least one sensor, the fluid flow regulating device configured to change the rate of input fluid flow when a signal from the at least one sensor indicates a change in the output fluid flow rate. In another embodiment, an overflow protection system for a fluid transfer system provides an alert when a change is detected in the output fluid flow rate. In one embodiment, a method for overflow protection in a fluid transfer system with an opening to the environment comprises sensing a reduction in output fluid flow and reducing the input fluid flow or providing an alert.

### CROSS REFERENCE TO RELATED APPLICATION

This application claims the benefit of U.S. Provisional Application No. 61/662,708 entitled “Alarm or inflow regulator based on outflow for a fluid transfer system” filed on Jun. 21, 2012, the entire contents are incorporated by reference herein.

### TECHNICAL FIELD

The subject matter disclosed herein generally relates overflow protection in fluid transfer systems with an opening to the environment and methods for regulating fluid flow and providing alerts to changes in fluid flow.

### BACKGROUND

One problem with commercial, residential, or governmental waste water systems is that fresh water, delivered under pressure, has the capacity to cause significant material damage to buildings and other structures, land, and possessions, as well as other financial loss due to, for example, the cost to clean up water damage. In particular, but without limitation, fresh water can cause damage when its inflow rate exceeds the outflow rate through the sewer or waste line. For example, one scenario in which inflow rate exceeds outflow rate occurs when there is a complete or partial blockage of one or more sewer lines, leading to a reduction in sewer outflow capacity of the system and a related accumulation of waste water in one or more sewer lines; under normal operation, the sewer outflow capacity would be sufficient to accommodate the maximum planned fresh water inflow, but the blockage reduces the outflow capacity. If inflow continues, the waste water may eventually overflow, and may damage structures, land, tangible property, and so forth that are subjected to the overflow.

Sewer or drain pipe system blockage can occur at any location in a pipe. Continued inflow of fresh water such as from a sink faucet or shower on the upstream or up-gradient side of the blockage causes the waste water to collect in the sewer pipe above the obstruction. If there is an opening in the sewer or drain pipe system, such as a sink drain or toilet or a vent for system pressure regulation, between the blockage and the water source, the accumulating waste water can eventually flow out this opening and result in damage or loss as described above. If the fresh water inflow location is the closest site to the blockage, the overflow can occur at this location, as might be observed, for example, from a sink with a blocked drain. The fresh water accumulates in the sink structure until the sink is full, and then overflows from the sink itself. A blockage or obstruction may be more difficult for a user to detect, and water overflow may continue indefinitely and cause greater damage if the overflow location is remote from the fresh water source; for example, this might occur when the overflow location and the fresh water source are on different floors of a building.

Sewer or drain pipe blockage can occur for several reasons, leading to a decrease in waste water outflow. Some blockages are due to mechanical obstruction, for example as a result of a wad of paper becoming lodged in the sewer pipe, accumulated sludge adhering to the inside of a pipe, the incursion of roots of plants into a pipe, or as a result of fracture, breakage, misalignment, crushing, deterioration or damage to a pipe. Other blockages are functional obstructions, for example as a result of high sewer line back pressure during periods of heavy rain water runoff entering the sewer system. In each such case, the waste water outflow capacity is reduced, increasing the risk of water overflow.

Existing solutions to mechanical obstructions include waiting for an overflow event and addressing it long after the fact, in which case damage may have occurred. Expensive preventative services include “rooting” or drilling pipes to attempt to ensure they are clear them of obstructions, whether or not such obstructions are then present, or scoping or otherwise inspecting or exploring pipes to check for obstructions to determine whether the pipes require such rooting or drilling. Existing solutions to functional obstructions include expensive overpressure pumping systems designed to force waste water into storm sewers in high backpressure situations, stand pipe systems designed to relieve pressure but not necessarily prevent flooding or overflow, and sump pumps which are subject to electrical power system failures and are typically designed to address seepage of ground water rather than flooding from sewer system overflow. Other fluid transfer systems with openings to the environment can also have these problems.

### SUMMARY

In one aspect, a system senses a status or change in status from an output fluid flow sensor or surrogate output fluid flow sensor and reports or responds to the status or change. In another aspect, a system senses status or changes in waste water flow or system pressure and reports and/or responds to the status or changes.

In a further aspect, when inadequate waste water flow or excessive pressure is detected, the system responds by: (a) emitting a signal or one or more of a predetermined set of signals or indications which may include sensor data or interpretations or conclusions based on sensor data, (b) causing a change or changes in flow rate of fresh water, including but not limited to discontinuation of flow, or (c) performing both functions and/or other functions.

In one embodiment, a fluid flow sensor and control unit is used to regulate fresh water or other incoming fluid flow, and sense a change or signal a sensed change in the waste, sewer, or other outgoing fluid flow. In one embodiment, the fluid flow or pressure sensed and/or regulated includes fresh water and waste water in residential, commercial, or governmental water and sewer applications; however other embodiments contemplate much broader potential industrial, commercial, scientific, research and other applications to the flow of many possible types of matter, compositions of matter and combinations of types and compositions of matter.

In one embodiment, a system for regulating input fluid flow to one or more fluidly connected regions of a fluid transfer system with an opening to the environment comprises at least one sensor providing a signal indicating a change in the rate of output fluid flow from the one or more fluidly connected regions of the fluid transfer system; and a fluid flow regulating device in communication with the at least one sensor, the fluid flow regulating device is operatively configured to change the rate of input fluid flow to the one or more fluidly connected regions of the fluid transfer system, wherein the fluid flow regulating device changes the rate of the input fluid flow to the one or more fluidly connected regions of the fluid transfer system when the signal from the at least one sensor indicates a change in the rate of the output fluid flow from the one or more fluidly connected regions of the fluid transfer system.

In another embodiment, a system for providing an alert indicating a change in a rate of output fluid flow in an output flow region fluidly connected to an input flow region of a fluid transfer system with the input flow region configured to receive fluid external to the fluid transfer system and the output flow region configured to discharge fluid from the fluid transfer system comprises: at least one sensor configured to detect an environmental change correlating to the rate of the output fluid flow in the output flow region of the fluid transfer system; and an alert mechanism in direct or indirect communication with the at least one sensor, wherein the alert mechanism provides a signal, indication, or response when the at least one sensor detects an environmental change correlating to a change in the rate of the output fluid flow in the output flow region of the fluid transfer system.

In a further embodiment, a method for protecting from fluid overflow in a fluid transfer system with an opening to the environment comprises: sensing a reduction in fluid flow in a fluid output region of the fluid transfer system configured to discharge output fluid out of the fluid transfer system; and reducing the fluid flow in a fluid input region of the fluid transfer system configured to receive input fluid into the fluid transfer system or providing an alert indicating the reduction in fluid flow in the fluid output region.

### BRIEF DESCRIPTION OF THE DRAWINGS

FIG. 1 is a stylized perspective view of a sewer pipe segment.

FIG. 2 is a stylized perspective view of a sewer pipe segment showing accumulation of waste water due to inadequate outflow.

FIG. 3 is a stylized perspective view of a flow sensing device of one embodiment of a fluid sensing and regulating system operatively coupled to a sewer pipe showing accumulation of waste water and a waste water flow sensor, power wires, and data wires.

FIG. 4 is a stylized perspective view of a control box enclosure with control unit of one embodiment of a fluid sensing and regulating system, sensor input lines, control output lines, status display, and control buttons.

FIG. 5 is a stylized perspective view of a fresh water inflow pipe with a control valve installed in-line in one embodiment of a fluid sensing and regulating system.

FIG. 6 is a stylized perspective view of one embodiment of a fluid sensing and regulating system.

FIG. 7 is a diagram of an embodiment of a fluid sensing and indication system.

FIG. 8 is a diagram of an embodiment of fluid sensing and regulating system.

FIG. 9 is a diagram of a flow chart for an embodiment of a fluid sensing and indication system.

FIG. 10 is a diagram of a flow chart for an embodiment of a fluid sensing and regulating system.

### LIST OF REFERENCE NUMERALS

310 Sewer outflow pipe segment, upstream side
312 Sewer outflow pipe segment, downstream side
313 Sewer outflow pipe
314 Waste water accumulation in pipe
316 Waste water flow or flow surrogate sensor(s) or flow sensing system
318 Waste water flow or flow surrogate sensor power wire(s)
320 Waste water flow or flow surrogate sensor data wire(s)
410 Control unit power wire(s)
412 Measurement value display(s)
414 Threshold value display(s)
416 Control unit control panel button(s)
418 Control unit signal(s)
419 Power output wire(s)
420 Control unit enclosure
432 Measurement value
434 Threshold value
422 Control unit
510 Fresh water inflow pipe, upstream segment
512 Fresh water inflow pipe, downstream segment
514 Fresh water flow regulator valve body and enclosures
600 Fluid sensing and regulating system for a sewer line
700 Fluid sensing and indication system
701 Outflow pipe
702 Fluid flow sensor or surrogate fluid flow sensor
703 Control unit
704 Signal or intervention
705 Fluid flow regulator
706 Fluid supply pipe

### DETAILED DESCRIPTION

The features and other details of several embodiments will now be more particularly described. It will be understood that particular embodiments described herein are shown by way of illustration and not as limitations. The principal features can be employed in various embodiments without departing from the scope of any particular embodiment.

### DEFINITIONS

As used herein, incoming matter may be referred to as “fresh water” and outgoing matter as “waste water,” and either may be referred to as “fluid flow” or as a “fluid”; any such references are for simplicity and ease of reference only and are not intended to and should not be interpreted to limit the scope of the invention to apply to use with water alone or to use only with matter that is a fluid at room temperature or at the temperatures that exist in the natural environment of the Earth's atmosphere or within typical residential or non-industrial commercial applications. The fluids and matter referenced herein are intended to be interpreted broadly to apply to all fluids and all matter with fluid-like behavior, in light of the knowledge of persons reasonably skilled in the art of the various sciences, engineering and applied-science disciplines, including those of thermodynamics, hydraulics and fluid mechanics, and should be read to apply to any incoming or outgoing matter or material with fluidic or fluid-like behavior at least at some time under certain conditions. These include fluids and materials that exhibit fluid-like behavior at some pressures and temperatures and not at others, and materials that exhibit phase changes induced by changing temperature or pressure or both, or by applying vibration, augers, drives, propellers, impellers, drills or other force. These also include fluids and materials where fluid-like behavior may exist or be induced in aggregates or forms of matter with weak crystalline bonds, or by any other method known to those reasonably skilled in the arts referenced above, including physics, chemistry, industrial engineering or wastewater management.

For the purposes of this document “fluids”, “flows”, “fresh water” and “waste water” may include gases, slurries, granular or aggregate solids capable of fluid-like flow, or other mixtures of gases, liquids or solids that are capable of fluid-like flow, regardless of specific chemical composition or specific character of the inflowing or outflowing conduit construction and regardless of whether fluid-like flow is a natural characteristic of the matter or material or whether the fluid-like-flow is induced. Flow should not be interpreted to impose a limit on the rate of flow, or assume flow under the force of gravity, or assume flow particles of any particular size, or assume that the flow should be consistent in rate or smooth in operation.

The use of “or” in this document is not intended to be exclusive unless otherwise specified or required by context. The use of the word “including” in this document shall mean “including without limitation”, unless otherwise specified or required by context; likewise “include”, “includes” and the like are not intended to be words of limitation and shall instead be deemed to be followed by “without limitation”. Also, the use of the words “for example” or words of similar intent in this document shall not be intended as words of limitation, but instead “for example” shall mean “for example but without limitation” and “such as” shall mean “such as but without limitation”.

Use Alone or in Combination with Other Solutions.

In one embodiment, a fluid flow sensor and control unit is used to regulate fresh water or other incoming fluid flow, and sense a change or signal a sensed change in the waste, sewer, or other outgoing fluid flow. The system may be used in a residential, commercial, or governmental water and sewer applications by itself or in combination with other products or solutions designed to protect from backflow, overflow or flooding, to reduce backflow, overflow or flooding, or prevent backflow, overflow or flooding, including those that regulate backflow from sewer systems that are not the result of overflow of fresh water or other incoming fluid flow by the user(s). In one embodiment, the fluid transfer system comprises a section of a water supply system for a commercial, residential, or government building such as, for example, the section of the system between the fresh water meter for a building and the output sewer line from the building. In one embodiment, the protection from backflow, overflow, or flooding is in the form of physical prevention or reduction in the severity of the backflow, overflow, or flooding such as by the reduction in input fluid flow. In another embodiment, the protection from backflow, overflow, or flooding is in the form of providing an alert to the fluid system user, owner, or manager that there is an imminent, potential, immediate, or future need to reduce the flow of input fluid to the system. In this embodiment, for example, the reduction in flow of input fluid to the system can be achieved by physically reducing the input fluid flow, restricting the use of the fluid system or regions of the fluid system, or notifying users to reduce the use of the fluid system.

It is noted that such backflow regulation products or solutions can operate by imposing an intentional mechanical obstruction between a building's or facility's internal sewer or drain pipe system (or a region thereof) and a municipal or other shared sewer system, which may protect such building or facility from the source of sewer backflow but simultaneously cause a potential overflow of fresh water or incoming fluid flow used by the users(s) in such building or facility by stopping or reducing the capacity for sewer or other outgoing fluid flow from such building or facility. It is further noted, that some such backflow regulation products or solutions may intend to clear, periodically, based on sensors or otherwise, such mechanical obstruction, for example through the use of high-pressure pumps to discharge the building's or facility's waste water into a municipal sewer system, but that while such pumps may be dependent on continued access to electrical power, the ability of the water user(s) in such building or facility may not depend on electrical power, and even when such backflow system is intended to prevent fresh water or other incoming fluid flow from overflowing, the absence of electrical power or another system failure may expose the building's or facility's sewer or drain pipe system to a risk of overflow. In one embodiment, the device or a system comprising the device comprises a backflow protection product that can address overflow by sensing and regulating flow the overflow of a building's or facility's sewer or drain pipe system resulting from fresh water or other incoming fluid flow. By continuously or frequently evaluating waste water flow adequacy and responding to changes in this flow, the system can help reduce the risk of water damage.

### Selected Advantages and Configurations.

In one embodiment the system reduces the risk of water damage by being operatively configured to perform one or more tasks selected from the group: automatically perform one or more pre-selected or user-selected actions to address the risk of overflow; permitting users to elect that this embodiment fail in the “safe” configuration; and allowing an option for the ability to self-configure based upon the initial or normal conditions in the system into which the system is installed. Additionally, in another embodiment, the system is operatively configured to use one or more inexpensive gas pressure sensors rather than more expensive immersible fluid pressure sensors.

In one embodiment, the system includes inexpensive, prefabricated components such as pressure sensors and control units to reduce the total cost of manufacture. In many different configurations, different components could be anticipated by persons skilled in the art when given this disclosure, resulting in different configurations suitable for various home, industrial, and governmental uses. Furthermore, embodiments using standardized fittings, pipes, valves, and power supplies, permit advantages such as ease of use in new construction or retrofitting to serve existing systems.

In one embodiment, a fluid control system contains a communication system, including without limitation, a wireless communication systems, and a power system, including without limitation a power system that need not be connected to electrical power utilities, to functionally interconnect components in physically distant locations. In this embodiment, the task of installing the system in situations where supply lines are physically distant from sewer lines is greatly simplified. In one embodiment, the system for protection from fluid overflow in a fluid transfer system comprises two or more components or devices selected from the group of sensors, signaling devices or components, intervention devices or components, programming devices or components, communication devices or components, power supplies, batteries, displays, and fluid transfer components (such as pipes, tubes, connectors, couplers, seals, valves, access ports, filters, etc.). In another embodiment, the system for protection from fluid overflow in a fluid transfer system is a single device with a plurality of components.

In one embodiment, the fluid control system comprises modular components with one or more redundant components, thus allowing for greater component fault tolerance and performance during adverse physical conditions.

While the figures show a limited installation of sensors and communication components, other embodiments can coordinate one or a plurality of sensing components and one or a plurality of communication components, including redundant or backup communication components.

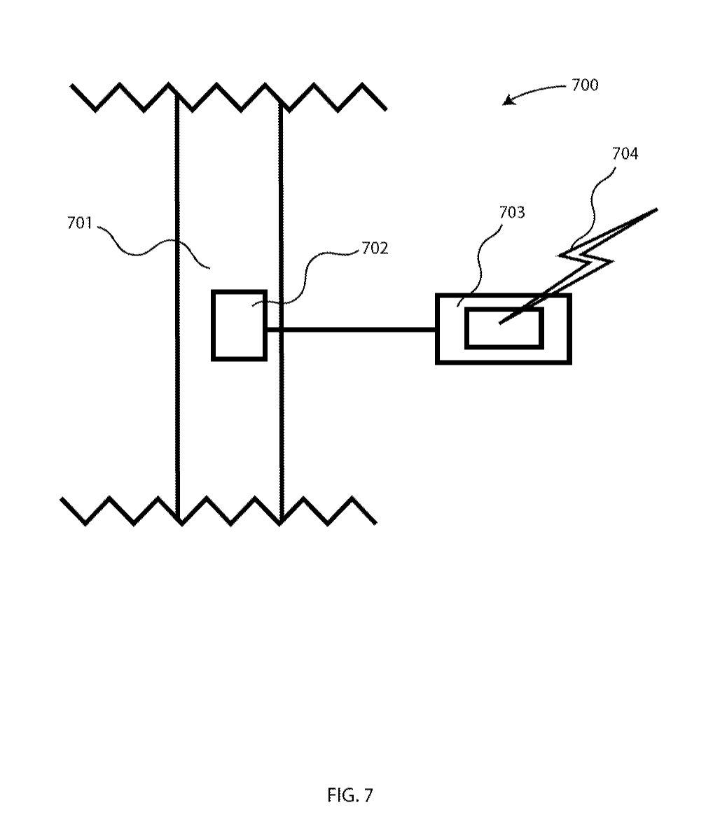

FIG. 7 is a diagram of an embodiment of a fluid sensing and indication system 700 for providing an alert related to a change in a rate of output fluid flow. The control unit 703 is operatively coupled to a fluid flow sensor or surrogate fluid flow sensor 702 operatively coupled to an outflow pipe 701. When the fluid flow sensor or surrogate fluid flow sensor 702 detects a change in the status of the fluid in the outflow pipe 701, the control unit 703 provides a signal or intervention 704 to indicate a status or change in status of the fluid in the outflow pipe 701. The signal or intervention may be visual, auditory, wired or wireless communication, electrical, optical, physical, mechanical or other signal or intervention discussed herein or known in the art.

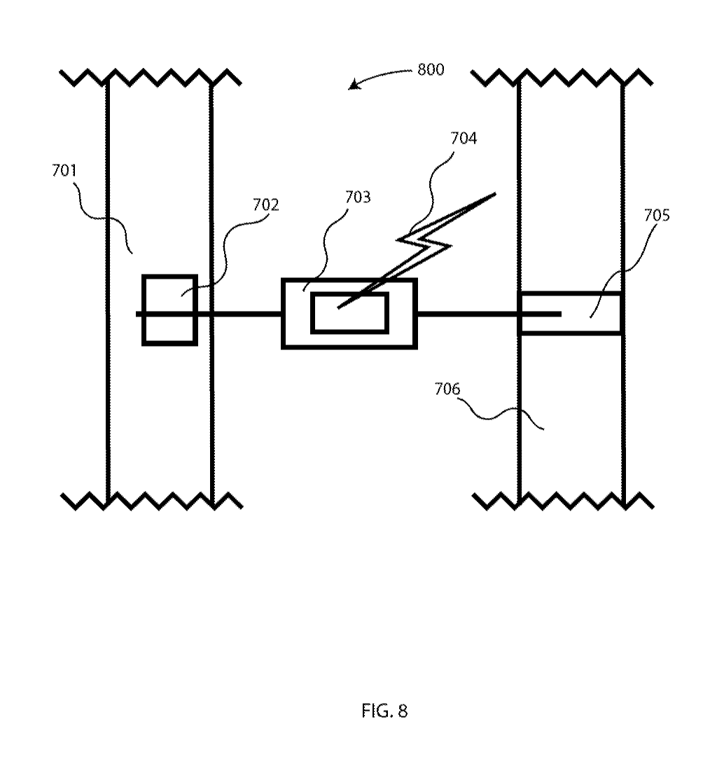

FIG. 8 is a diagram of an embodiment of fluid sensing and regulating system 800. The control unit 703 is operatively coupled to a fluid flow sensor or surrogate fluid flow sensor 702 operatively coupled to an outflow pipe 701. When the fluid flow sensor or surrogate fluid flow sensor 702 detects a change in the status of the fluid in the outflow pipe 701, the control unit 703 directs the fluid flow regulator 705 operatively coupled to the control unit 703 and the fluid supply pipe 706 to stop or reduce supply fluid flow. The control unit may optionally provide a signal or intervention 704 to indicate a status or change in status of the fluid in the outflow pipe 701. The signal or intervention may be visual, auditory, wired or wireless communication, electrical, optical, physical, mechanical or other signal or intervention discussed herein or known in the art.

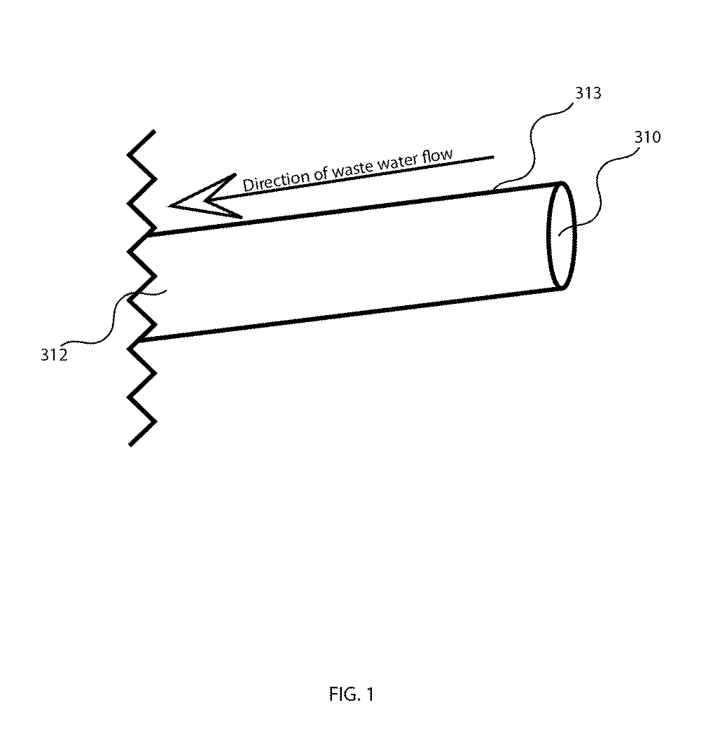

FIG. 1 shows a stylized segment of a sewer outflow pipe 313 with upstream side 310 and downstream side 312, during normal circumstances. The sewer outflow pipe 313 may also be a waste water pipe or other sewer line. Water flows down a gradient, in this case from right to left, but does not accumulate in the pipe under normal circumstances. The drawing is highly stylized. Actual sewer pipes may contain joints, elbows, bends, valves, clean-out access ports, additional incoming or outgoing pipe segments, and other variations, known to those of reasonable skill in the art, which are not depicted here. As is known to those reasonably skilled in the art, waste water under pressure may also flow up gradients in elevation, forced by gradients in pressure, rather than gradients in elevation per se, which gradients in pressure, driven by elevation or other forces, effect the flow of waste water generally.

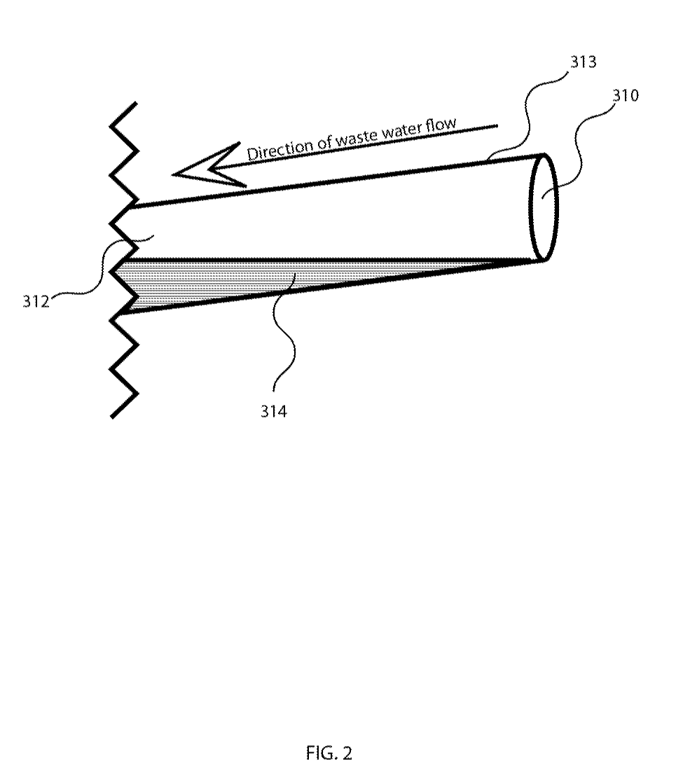

FIG. 2 shows the same stylized segment of a sewer outflow pipe 313 with an upstream side 310 and downstream side 312 as in FIG. 1, but during circumstances of inadequate waste water outflow. Waste water 314 is seen accumulating in the lower part of the sewer pipe 313, self-leveling due to gravity. As additional waste water flows into this pipe segment from the right side, the depth of the accumulating waste water 314 will increase in the sewer pipe 313. The leading edge of accumulated waste water 314 will also progress to the right as additional waste water is added. In one embodiment, the system is operatively configured to function in both pressurized, gravity fed, waste water systems and pressurized waste water systems, including wastewater systems that regulate excessive back pressure.

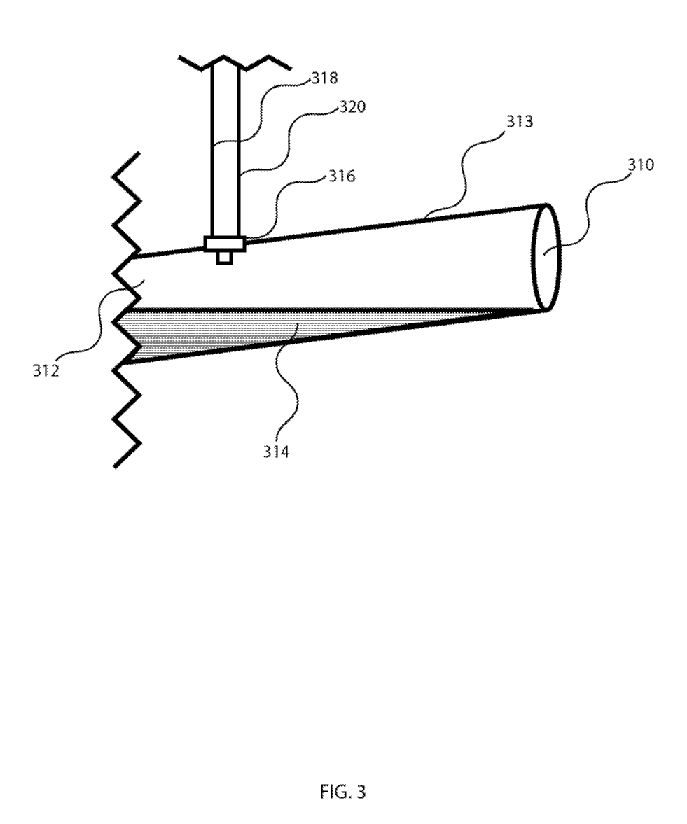

FIG. 3 is a stylized perspective view of a flow sensing device 316 of one embodiment of a fluid sensing and regulating system operatively coupled to a sewer pipe 313 showing accumulation of waste water. The upstream side 310 of the sewer pipe, 313, and downstream side 312 of the sewer pipe, 313, are depicted, along with the accumulated waste water 314. In this embodiment, the flow sensing device 316 is operatively connected to power wires 318 and data wires 320 to detect waste water flow. In another embodiment, the flow sensing device 316 is a flow surrogate sensing device or method.

### Alternative Sensor Locations.

Wherein FIG. 3 depicts one possible location for the flow sensing device 316, the sewer pipe configuration, sensor types and locations can vary greatly. In another embodiment, the flow sensing device 316 is mounted on the side or bottom of the sewer pipe 313, or incorporated into the mounts, struts, pylons, or other supporting structures used to suspend or locate the sewer pipe itself.

The flow sensing device 316 depicted in FIG. 3 is a gas pressure sensor in the dry portion of an enclosed cavity with at least one opening to the monitored pipe. The enclosed cavity is above (or up-gradient from) waste water but below any point of possible overflow exit, which presents the advantage that if waste water normally covers such opening(s) or, alternatively, does not normally cover such opening(s) but in a potential overflow situation backs up and encloses the cavity, the system will be configured to interact with the gas pressure sensor to detect changes in the pressure of the enclosed volume of gas. In one embodiment, the flow sensing device is installed in a vent for the sewer or drain pipe system or another pipe open to the atmosphere, which may be periodically or otherwise closed to the atmosphere to check for changes in system pressure.

### Alternative Sensing Methods and Devices

In one embodiment, the flow sensing device is a sensor that provides a signal correlating to a change in the output fluid flow in an output region of a fluid transfer system. The correlation may be direct (as in a sensor providing the flow rate) or indirect such as a sensor measuring a change in an environmental property such as pressure or presence of a liquid. For example, in one embodiment, a sensor provides an increased voltage signal corresponding to increased pressure indicating a reduction in output fluid flow for the fluid transfer system. In one embodiment, a surrogate measurement sensing method, device, or system is used to detect and monitor waste water flow. In addition to other sensors or methods of measurement or sensing known to those reasonably skilled in the art, waste water flow or surrogate measurement sensing methods may include: direct sensor measurement of waste water flow rate (paddle wheel(s), propeller(s), impeller(s), etc.); gas or vapor pressure sensor(s); hydraulic or fluid pressure sensor(s); mass or weight sensor(s) measuring a segment of the sewer pipe; inductive, resistive, or conductive sensor(s) detecting changes in the sewer pipe or contents; mechanical float sensor(s) to detect changes in the waste water height; ultrasound sensor(s) or other means of detecting change in flow (for example, from Doppler measurements), fluid height, or accumulated water presence; optical sensor detecting changes in flow rate or accumulated water presence; thermodilution sensor flow detection techniques; density sensor; and external pressure sensor.

For example, the sensor could detect the outward deformation of a special segment of sewer pipe that stretches in response to increases in sewer pipe pressure. This might, for example, entail a small window cut into the sewer pipe and sealed with a piece of rubber. As the pressure in the pipe increases, the compliance of the rubber allows it to expand outward at a greater rate than the sewer pipe, indicating an increased pressure within the pipe. Other suitable surrogate measurements would be capable of indicating the failure for waste water to flow adequately through the sewer pipe.

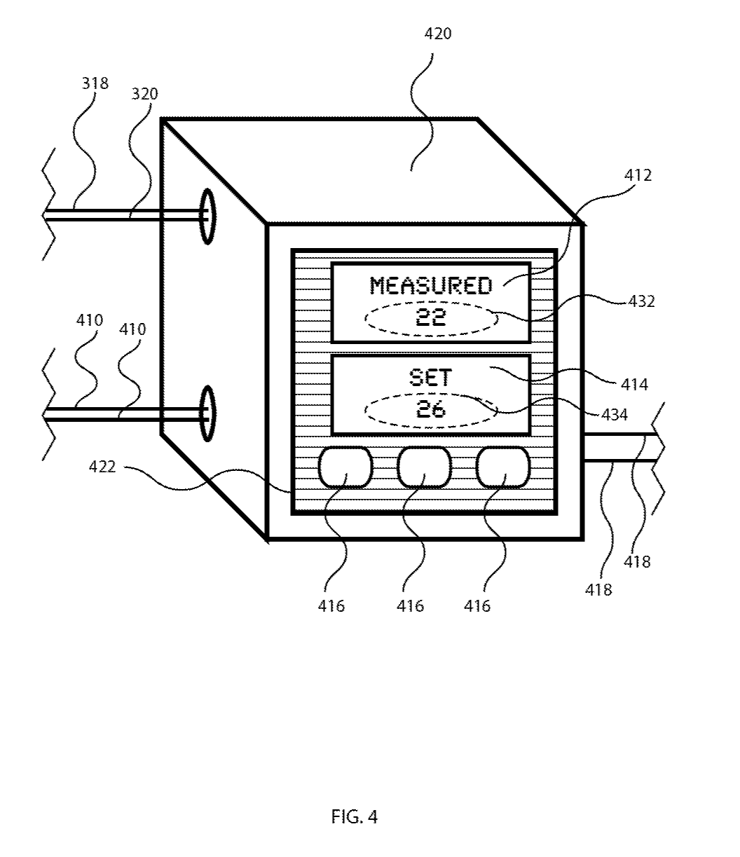

FIG. 4 is a stylized perspective view of a control unit 422 within an enclosure 420 of one embodiment of a fluid sensing and regulating system. In this embodiment, the control unit 422 is an electrically powered, solid state, digital control unit with power supply wires 410. The control unit 422 provides the waste water flow sensor power wires 318 and receives the waste water flow sensor data wires 320. The control unit 422 provides signal and AC line output wires 418. The control unit 422 has status displays 432, 434 showing the waste water flow sensor measurement value 412 and the control unit response threshold or set point value 414, respectively. The threshold and other parameters of the control unit are adjusted by pressing the control unit control panel buttons 416 in a specific sequence. When the measurement value 432 shown in the measurement display 412 exceeds the threshold value 434 shown in the threshold display 414, the control unit 422 applies an AC current and voltage to the output wires, 418. In another embodiment, when the measurement value is less than a threshold value, the control unit may direct the fluid flow regulating device to decrease the input fluid flow.

### Alternative Sensing, Signaling and Intervention Means.

While FIG. 4 depicts a control unit of one embodiment of a fluid sensing and regulating system, other embodiments of the control unit include digital, analog, or mechanical control unit capable of monitoring the sensed value and signaling, responding, and intervening with means well understood by practitioners of the art of signal communication.

Types of sensing and signaling include threshold response, wherein the responses occurs when the sensed value exceeds a threshold value or the response stops when a sensed value is lower than threshold; trip and latch response, wherein a response occurs when a sensed value exceeds threshold or the sensor/control unit must be manually reset to terminate the response; and hysteresis response, wherein a response occurs when a sensed value exceeds a threshold value and the response stops when the sensed value is lower than a second, lower threshold.

In some embodiments, the threshold value may be a negative value, null or zero value, or the absence of a signal (also considered herein to be a zero value). In other embodiments, the threshold value may be simply the presence of a signal, such as the presence of a voltage difference relative to a reference such as ground. In one embodiment, the signal is a binary signal with an on/off, zero/one, or first value/second value signal.

Types of signal, responses, or intervention also include generation, modulation, removal, or other change of a current, voltage, or alternative source of power on the output wires, 418; generation, modulation, removal, or other change of an electromagnetic, acoustic, thermal, mechanical, or other output; audible alert at the control box location or at a distant location or locations such as in the vicinity of fresh water supply points. Audible alerts include alarm sounds, speech synthesis, speech recording, or other audible message formats.

Types of signals or responses also include visible alert at the control box location or at a distant location or locations such as in the vicinity of fresh water supply points. Visible alerts include display of warning lights, icons, messages, or other visible message formats. Types of signals or responses also include tactile or other haptic alert at the control box location or at a distant location or locations such as in the vicinity of fresh water supply points. For example, the control unit could control a mechanical hammer that could repeatedly impact the fresh water pipe, causing a vibration that the user could feel or hear at the fresh water supply point.

Types of signal, response, or intervention also include water flow interruption; water flow modulation, for example by statically decreasing water flow rate; or water flow signaling. For example, the unit could decrease then increase the fresh water flow rate, thus alerting users to the sensed outflow deficiency without entirely depriving said user of fresh water. The flow changes could be repeatedly cycled, for example, ensuring that all subsequent users would also be informed of the waste water outflow deficiency.

Types of signal or intervention also include water temperature signaling. For example, the unit could vary the hot and cold water flow rates independently, creating a temperature variation signal. Types of signal also included delivery of a message via analog or digital message delivery systems such as phone calls, pagers, e-mail, SMS “texting” or use of another messaging protocol, delivering information to a home automation or building automation system or control device, Web site posting, social networking posting, or other modes of communication. In one embodiment, the system delivers output flow information to a water supplier, such as a municipal water service, to assist in the diagnosis of a problem and/identification of the location of waste water backup for troubleshooting and/or redirecting water flow.

### Alternative Programming, Communication and Display Means.

While FIG. 4 depicts one embodiment of a fluid sensing and regulating system, other embodiments of the control unit include digital, analog, or mechanical control unit capable of programming, communicating, displaying, and other functions via with means well understood by practitioners of the art of signal communication, including onboard buttons; onboard display; remote programming via wired, wireless, optical, acoustic, or other data transmission means; remote data display via wired, wireless, optical, acoustic, or other data transmission means; delayed data display, processing, or delivery via wired, wireless, optical, acoustic, or other data transmission means.

In one embodiment, the system provides the alert and/or regulates input fluid flow using only mechanically actuated components such as for example, in a mechanically actuated system.

In another embodiment, the system does not electronically or otherwise communicate a measured and/or set value. In another embodiment, the measured and/or set value is communicated between a control unit and sensor, but not displayed in the system. In one embodiment, one or more components in the system, such as for example, the sensor or control unit is preset with an initial value, such as a calibration value. In this embodiment, when the measured value of the sensor reaches the initial value, a signal, and not necessarily the value data, is transmitted to the control unit to provide an alarm, indication, response or regulate incoming fluid flow. In another embodiment, the sensor has a built in mechanical, physical, electrical or other calibration or configuration such that when a sensor measured value reaches a preset value, installer set value, or value set by the user or an external system, the sensor or other system component generates a signal, indication, or response, or directly regulates the incoming fluid flow with or without the use of a control unit. For example, in one embodiment, the system comprises an outflow pressure sensor electrically coupled to a latching relay that is electrically coupled to a valve for the incoming water flow. In this example, when the pressure in the outflow sensor reaches a set value, the latching relay switches and causes the incoming water flow to reduce or stop without the signal passing through a separate control unit. In another embodiment, a mostly or entirely mechanical system contains one or more pressure valves, actuators, or sensors operatively coupled to each other that reduce or close incoming fluid flow when the outgoing fluid pressure increases to a certain value.

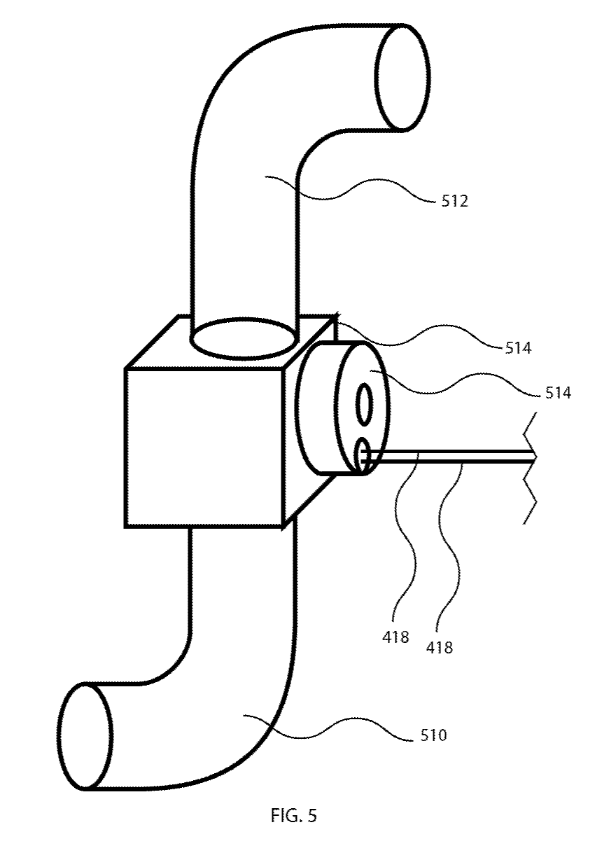

FIG. 5 is a stylized perspective view of a fresh water inflow pipe with control valve installed in-line in one embodiment of a fluid sensing and regulating system. The fresh water flow regulator valve 514 is installed in-line in the fresh water supply line, between the upstream fresh water supply pipe 510 and downstream fresh water supply pipe 512. In one embodiment, AC current and voltage applied to the flow regulator valve 514 using the power wires 418 will actuate a solenoid, closing the flow regulator valve 514 and stop the flow of fresh water. In this embodiment, the fresh water supply line is regulated by a response to a super-threshold signal as sensed by the control unit 422 (FIG. 4). Various other possible responses may be used. In some embodiments, it may be preferable to regulate the flow of fresh water automatically, under the control of the control unit 422 (FIG. 4). The signal to regulate water flow in other embodiments may include direct, “hard-wired” electrical, electromagnetic, electrical, acoustic, optical, thermal, mechanical, or other signaling means. In other embodiments, it may be preferable to avoid altering the fresh water flow in favor of presenting a signal or alert, such as a status signal, or visible, tactile, audible, or other alert as described herein.

### Alternative Intervention, Signalling and Flow Regulation Means

Fresh water regulation responses may include use of solenoid valve in-line with the fresh water supply controlled by applied mechanical actuation, voltage, or current. The solenoid valve can be of the “Normally Open” type, meaning that flow is permitted past the valve UNTIL a voltage or current is supplied. The solenoid valve can be of the “Normally Closed” type, meaning that flow is permitted past the valve WHEN a voltage or current is supplied. The choice of solenoid valve type will necessitate the proper programming of the control unit. The solenoid can alternatively be actuated by hydraulic, steam or gas, mechanical, thermal, or other means.

Fresh water regulation responses may also include use of screw type water flow regulation valve in-line with the fresh water supply that can modulate water flow as a result of turning a threaded valve stem into or out of the water flow path. In one embodiment, an actuator responds to supplied mechanical actuation, current, or voltage to advance or retract the threaded valve stem unit to regulate fresh water flow. The actuator can alternatively be actuated by hydraulic, steam or gas, mechanical, thermal, or other means.

Fresh water regulation responses may also include use of ball valve type water flow regulation with electric, hydraulic, steam or gas, mechanical, thermal, or other actuator.

Fresh water regulation responses may also include use of a bypass pipe that can divert fresh water flow from the normal supply line to a secondary circuit. This might route water back to a local well, for example, allowing a well pump to continue normal operation, but preventing fresh water supply from reaching supply points beyond the location of the bypass takeoff. Control of the bypass flow could be by electric, hydraulic, steam or gas, mechanical, thermal, or other actuator.

Fresh water regulation responses may also include other fresh water flow control apparatus which can respond to signals from the control unit, known to those skilled in the art.

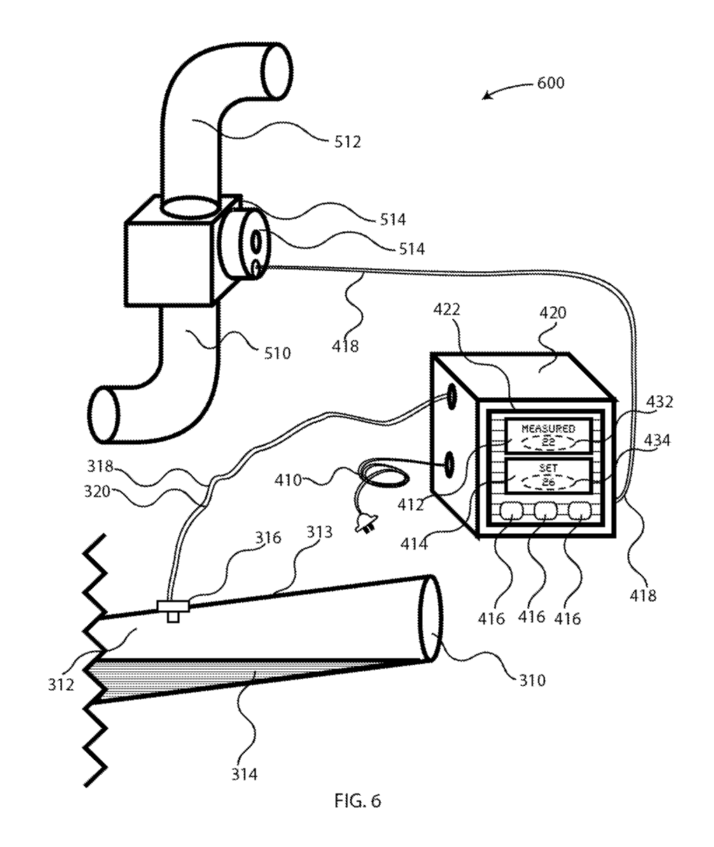

FIG. 6 is a stylized perspective view of one embodiment of a fluid sensing and regulating system 600. In this embodiment, the sewer outflow pipe 313 is depicted with upstream side 310 and downstream side 312. An accumulation of waste water 314 is depicted in the pipe suggesting inadequate waste water outflow. Control unit 422 is powered by AC power carried on wires 410. The flow sensing device 316 is powered by wires 318 from the control unit 422. The flow sensing device 316 sends flow sensor data via the waste water flow sensor data wires 320 to the control unit 422. The threshold value 434 for the control unit 422 to respond to waste water flow changes is set using buttons 416. When the waste water flow sensor signal value 432, shown on display 412, exceeds the threshold value 434, shown on display 414, the control unit 422 applies AC power (voltage and current) to wires 418. Wires 418, when powered, actuate the fresh water flow regulator valve 514 solenoid, interrupting fresh water flow between the upstream fresh water supply pipe 510 and the downstream fresh water supply pipe, 512.

### Alternative Configurations.

While FIG. 6 depicts an embodiment using three interconnected units, other system embodiments might be assembled as one physical unit, or may be divided into an arbitrary number of subunits. These subunits may communicate with one another in various ways, depending on the specifics of the embodiment. For example, the waste water flow sensor may be self-powered by battery rather than via wires 318. The waste water flow sensor may send a signal via electromagnetic radiation, sound, ultrasound, thermal, mechanical, gas or steam pressure, or other signaling means rather than via wires 320. In embodiments using fresh water control valves, the valves may be signaled via electromagnetic radiation, sound, ultrasound, thermal, mechanical, gas or steam pressure, or other signaling means rather than via wires 418.

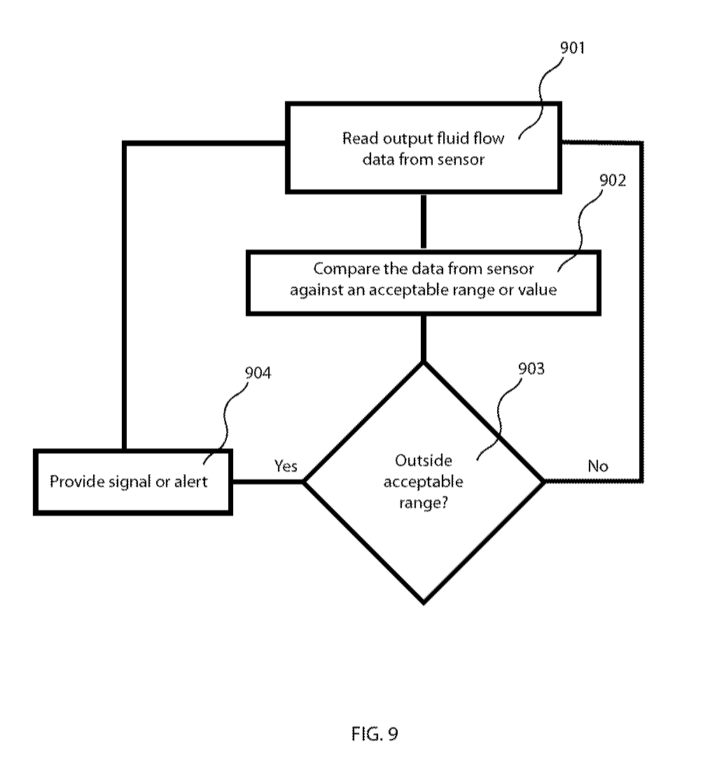

FIG. 9 is a diagram of a flow chart for an embodiment of a fluid sensing and indication system. The output fluid flow data from the sensor is read 901 and the data is compared against an acceptable range or value 902. The value could be, for example, a threshold value, and the range could be, for example an operating pressure range. A determination is made of whether or not the data is outside the acceptable range 903. If the data is not outside the acceptable range, the system continues reading the output fluid flow data from the sensor 901 at regular or other intervals. If the data is outside the acceptable range, then the system provides a signal or alert 904 and continues reading the output fluid flow data from the sensor 901 at regular or other intervals. If the output flow data from the sensor returns to an acceptable range, then the alert may stopped, changed, or require manual reset.

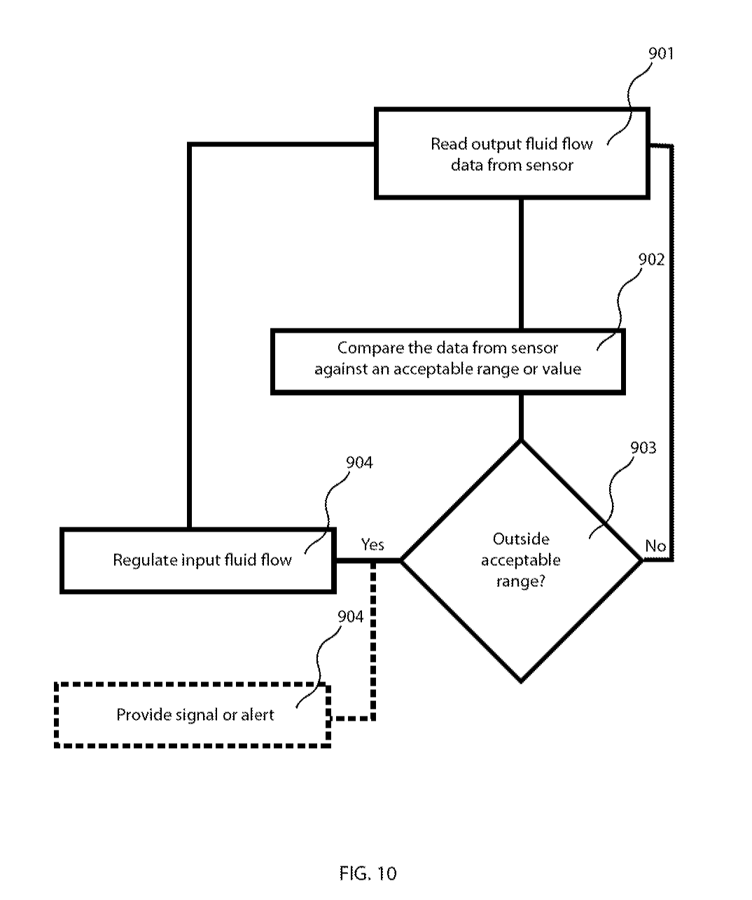

FIG. 10 is a diagram of a flow chart for an embodiment of a fluid sensing and regulating system. The output fluid flow data from the sensor is read 901 and the data is compared against an acceptable range or value 902. The value could be, for example, a threshold value, and the range could be, for example, an operating pressure range. A determination is made of whether or not the data is outside the acceptable range 903. If the data is not outside the acceptable range, the system continues reading the output fluid flow data from the sensor 901 at regular or other intervals. If the data is outside the acceptable range, then the system regulates the input fluid flow, such as by stopping the input fluid flow, for example. The system continues reading the output fluid flow data from the sensor 901 at regular or other intervals. If the output flow data from the sensor returns to an acceptable range, then the input flow may be adjusted to the original or different state. If the data is outside the acceptable range, the system may optionally provide a signal or alert 904.

In one embodiment, a method of indicating a fluid output flow change includes: reading output fluid flow data from a sensor; comparing the output fluid flow data against an acceptable range or value; and providing a signal or alert if the data is outside an acceptable range. In another embodiment, a method of regulating input fluid flow includes: reading output fluid flow data from a sensor; comparing the output fluid flow data against an acceptable range or value; and regulating the input fluid flow if the data is outside an acceptable range. In one embodiment, the method of regulating input fluid flow further comprises providing a signal or alert if the data is outside an acceptable range or value. In another embodiment, the method of regulating input fluid flow includes closing a valve to stop input fluid flow.

What is claimed is:

1. A system for regulating input fluid flow to one or more fluidly connected regions of a fluid transfer system with an opening to the environment, the system comprising:
a. at least one sensor providing a sensor signal indicating a change in the rate of output fluid flow from the one or more fluidly connected regions of the fluid transfer system; and
b. a fluid flow regulating device in communication with the at least one sensor, the fluid flow regulating device is operatively configured to change the rate of input fluid flow to the one or more fluidly connected regions of the fluid transfer system, wherein the fluid flow regulating device changes the rate of the input fluid flow to the one or more fluidly connected regions of the fluid transfer system when the sensor signal from the at least one sensor indicates a change in the rate of the output fluid flow from the one or more fluidly connected regions of the fluid transfer system.

2. The system of claim 1 wherein the fluid flow regulating device reduces the rate of the input fluid flow or stops the input fluid flow to the one or more regions of the fluid transfer system when the rate of the output fluid flow is reduced or the output fluid flow is stopped.

3. The system of claim 2 wherein the system is a mechanically actuated system, the fluid flow regulating device is a mechanically actuated device, and the fluid flow regulating device is in mechanical communication with the at least one sensor.

4. The system of claim 2 wherein the fluid flow regulating device increases the rate of input fluid flow to one or more regions of the fluid transfer system when the rate of output fluid flow is increased.

5. The system of claim 1 further comprising a control unit operatively configured to receive the sensor signal from the at least one sensor and direct the fluid flow regulating device to increase or decrease the rate of input fluid flow when the sensor signal exceeds a threshold value or when the sensor signal is lower than a threshold value.

6. The system of claim 5 wherein the at least one sensor or the control unit is preset with the threshold value; the at least one sensor or the control unit has a built-in calibration method that generates the threshold value; or the at least one sensor and/or control unit is operatively configured with a user-configurable calibration method that generates the threshold value.

7. The system of claim 1 wherein the fluid transfer system comprises a section of a water supply system for a commercial building, a residential building, or a government building, and the one or more fluidly connected regions comprise a fresh water input region and a waste water output region.

8. The system of claim 7 further comprising a control unit operatively configured to receive the sensor signal from the at least one sensor and direct the fluid flow regulating device to decrease the rate of input fluid flow to the fresh water input region when the sensor signal is above or below a threshold value due to the change in the rate of the output fluid flow in the waste water output region.

9. A system for providing an alert indicating a change in a rate of output fluid flow in an output flow region fluidly connected to an input flow region of a fluid transfer system with the input flow region configured to receive fluid external to the fluid transfer system and the output flow region configured to discharge fluid from the fluid transfer system, the system comprising:
a. at least one sensor configured to detect an environmental change correlating to the rate of the output fluid flow in the output flow region of the fluid transfer system; and
b. an alert mechanism in direct or indirect communication with the at least one sensor, wherein the alert mechanism provides a signal, an indication, or a response when the at least one sensor detects an environmental change correlating to a change in the rate of the output fluid flow in the output flow region of the fluid transfer system.

10. The system of claim 9 wherein the at least one sensor provides a sensor signal indicating a change in the rate of the output fluid flow from the output flow region of the fluid transfer system, the system further comprising a control unit operatively configured to receive the sensor signal from the at least one sensor and automatically direct the alert mechanism to provide the signal, the indication, or the response when the sensor signal exceeds a threshold value or when the sensor signal is lower than a threshold value.

11. The system of claim 9 wherein the signal, the indication, or the response is visual, auditory, wired or wireless communication, electrical, optical, physical, or mechanical.

12. The system of claim 9 wherein
a. the fluid transfer system comprises a section of a water supply system for a commercial building, a residential building, or a government building;
b. the input flow region comprises a fresh water input region;
c. the output flow region comprises a waste water output region; and
d. the fresh water input region is fluidly connected to the waste water output region.

13. The system of claim 12 wherein the alert mechanism provides the signal, the indication, or the response when the rate of the output fluid flow in the waste water output region is reduced or stopped.

14. The system of claim 12 further comprising a fluid flow regulating device operatively configured to change the rate of the input fluid flow in the fresh water input region, wherein the fluid flow regulating device changes the rate of input fluid flow in the fresh water input region when the at least one sensor detects an environmental change correlating to a change in the rate of the output fluid flow in the output flow region of the fluid transfer system.

15. The system of claim 14 wherein the signal, the indication, or the response is one or more selected from the group: water flow interruption, water flow modulation, and water temperature signaling.

16. A method for overflow protection in a fluid transfer system with an opening to the environment, the method comprising:
a. sensing a reduction in fluid flow in a fluid output region of the fluid transfer system configured to discharge output fluid out of the fluid transfer system; and
b. reducing the fluid flow in a fluid input region of the fluid transfer system configured to receive fluid into the fluid transfer system or providing a first alert indicating the reduction in fluid flow in the fluid output region.

17. The method of claim 16 wherein the first alert is a signal, an indication, or a response selected from the group: visual, auditory, wired or wireless communication, electrical, optical, physical, mechanical, water flow interruption, water flow modulation, and water temperature signaling.

18. The method of claim 16 wherein the fluid transfer system comprises a section of a water supply system for a commercial building, a residential building, or a government building; the fluid output region is a waste water output region; and the input region is a fresh water input region.

19. The method of claim 16 wherein sensing the reduction in fluid flow in the fluid output region of the fluid transfer system comprises at least one sensor providing a sensor signal to a control unit; the method further comprising the control unit analyzing the sensor signal; and the reducing the fluid flow in the fluid input region or the providing the first alert is directed by the control unit when the sensor signal exceeds a threshold value or when the sensor signal is lower than a threshold value.

20. The method of claim 19 further comprising:
a. sensing an increase in fluid flow in the fluid output region of the fluid transfer system; and
b. increasing the fluid flow in the fluid input region or providing a second alert when the sensor signal exceeds the threshold value or when the sensor signal is lower than the threshold value.
